(19) United States
(12) Patent Application Publication
(10) Pub. No.: US 2003/0210191 A1
(43) Pub. Date: Nov. 13, 2003

(54) Embedded antennas for a communications device

(76) Inventors: Alireza H. Mohammadian, San Diego, CA (US); Ernest T. Ozaki, Poway, CA (US); Patrick J. Connor, Encinitas, CA (US)

Correspondence Address: Qualcomm Incorporated, Patents Department, 5775 Morehouse Drive, San Diego, CA, 92121-1714, US

(21) Appl. No.: 10/142,603

(22) Filed: May 8, 2002

(51) Int. Cl. H01Q 1/24

(52) U.S. Cl. 343/702

(57) ABSTRACT

An embedded antenna subsystem wherein a board supports electronic components and a pair of radiating elements are mounted along the periphery of the board. It is emphasized that this abstract is provided to comply with the rules requiring an abstract which will allow a searcher or other reader to quickly ascertain the subject matter of the technical disclosure. It is submitted with the understanding that it will not be used to interpret or limit the scope or the meaning of the claims.

### BACKGROUND

1. Field

The present invention relates generally to communications technology, and more specifically, to embedded antennas for a communications device.

2. Background

Wireless high data rate services are considered to be the next important application in the telecommunications industry. The availability of low cost, high performance, aesthetically pleasing portable devices will encourage wide scale acceptance of these services by the masses. However, single antennas currently used on portable devices do not provide the data rates necessary for the next generation of high data rate services.

One way to support high data rate services is to use two antennas on the device and to implement diversity combining techniques to improve the overall signal to interference and noise ratio (SINR) compared to that of a single antenna. Currently, there are many desktop modems with dual antenna arrangements, however, they typically implement bulky and expensive sleeve dipole antennas that are spaced several inches apart, making the total modem package large and its cost high. Hence, low cost, small size, aesthetically pleasing antennas are desired for portable devices capable of offering high data rate services.

### SUMMARY

In one aspect of the present invention, an apparatus includes a board configured to support a plurality of electronic components, the board having a periphery, and a pair of radiating elements located adjacent the periphery of the board.

In another aspect of the present invention, a method of communications includes coupling a signal between a wireless communications medium and a plurality of electronic components supported by a board having a periphery, the coupling of the signal between the wireless communications medium and the electronic components being performed with a pair of radiating elements located adjacent the periphery of the board.

In yet another aspect of the present invention, an apparatus includes support means for supporting a plurality of electronic components, the support means having a periphery, and a pair of radiating means for coupling a signal between the electronic components and a wireless communications medium, the radiating means each being located adjacent the periphery of the support means.

It is understood that other aspects of the present invention will become readily apparent to those skilled in the art from the following detailed description, wherein is shown and described only exemplary embodiments of the invention, simply by way of illustration. As will be realized, the invention is capable of other and different embodiments, and its several details are capable of modifications in various respects, all without departing from the invention. Accordingly, the drawings and description are to be regarded as illustrative in nature, and not as restrictive.

### BRIEF DESCRIPTION OF THE DRAWINGS

Aspects of the present invention are illustrated by way of example, and not by way of limitation, in the accompanying drawings in which like reference numerals refer to similar elements wherein:

FIG. 1 is a perspective view of an exemplary inverted F antenna;

FIG. 2 is a perspective view of an exemplary planar inverted F antenna;

FIG. 3 is a perspective view of an exemplary antenna subsystem utilizing a pair of planar inverted F antennas mounted on a printed circuit board; and

FIG. 4 is an exploded view of an exemplary high data rate modem for a laptop computer.

### DETAILED DESCRIPTION

The detailed description set forth below in connection with the appended drawings is intended as a description of exemplary embodiments of the present invention and is not intended to represent the only embodiments in which the present invention can be practiced. The term “exemplary” used throughout this description means “serving as an example, instance, or illustration,” and should not necessarily be construed as preferred or advantageous over other embodiments. The detailed description includes specific details for the purpose of providing a thorough understanding of the present invention. However, it will be apparent to those skilled in the art that the present invention may be practiced without these specific details. In some instances, well known structures and devices are shown in block diagram form in order to avoid obscuring the concepts of the present invention.

In an exemplary embodiment of a communication device, an embedded antenna subsystem can be utilized. The embedded antenna subsystem may be supported by a printed circuit board (PCB) that is part of the internal electronics. This approach enhances the aesthetics of the communications device as well as provides increased user convenience by eliminating the need to deploy the antennas during use. The embedded antenna subsystem may be implemented with a pair of low profile radiating elements. The radiating elements may be located near the periphery of the PCB to compensate for any loss in bandwidth due to their relatively thin structure. In some applications, the radiating elements can be arranged on the PCB to allow for diversity combining gain.

The radiating elements may be implemented with a variety of technologies depending on the specific application and the overall design constraints. For communications devices attached to a conducting surface such as a laptop, a conductor-back type antenna should be used. A conductor-back type antenna can be implemented with an inverted F antenna, a planar inverted F antenna (PIFA), a rectangular microstrip patch, or any other similar antenna known in the art.

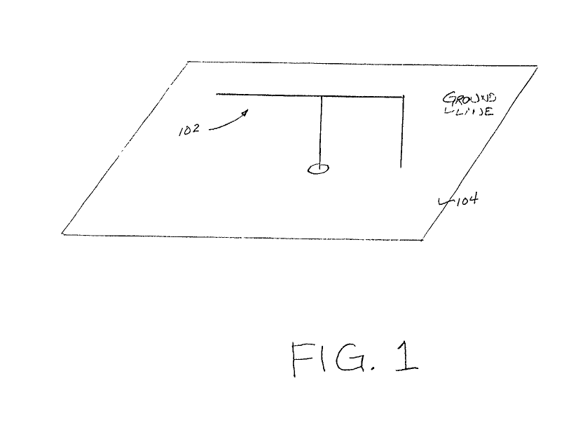

An exemplary inverted F antenna is shown in FIG. 1. The inverted F antenna can be formed from a piece of wire 102 shaped like the letter F and installed over a ground plane 104 after turning the two legs of the F by 90 degrees. The outer leg of this inverted F antenna can be connected to the ground plane 104. The other leg can be used to feed the signal to the horizontal wire.

In some applications, the inverted F antenna may not provide the desired bandwidth or efficiency. In these applications, a fairly large conducting surface may be used to increase the performance of the communications device. By way of example, the inverted F antenna could be replaced with a PIFA. The PIFA may be regarded as an inverted F antenna with the horizontal wire being replaced with a conducting plate. Alternatively, a rectangular microstrip patch antenna may be used.

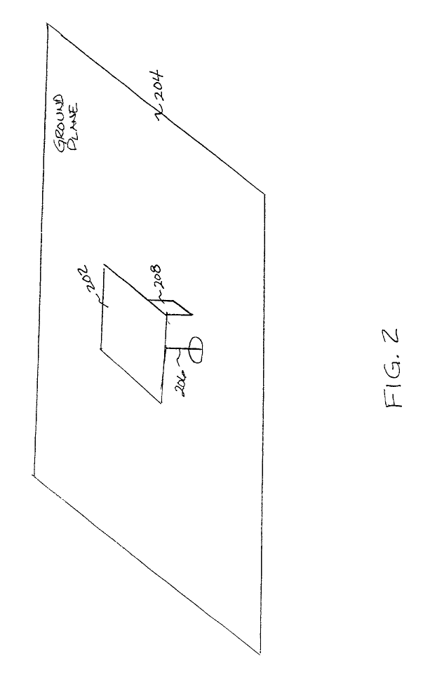

The PIFA may be regarded as a special case of a rectangular microstrip patch antenna. A microstrip patch antenna includes a patch positioned over a ground plane with a dielectric layer sandwiched in between the patch and the ground plane. The lowest order mode of this antenna corresponds to a frequency whose wavelength is roughly twice the size of the longest linear dimension of the patch. The electric field under the patch is predominantly perpendicular to the ground plane and goes to zero over a perpendicular plane that bisects the patch. Accordingly, one-half of the patch can be removed and the remaining half of the patch can be shorted to the ground plane with a shorting plate without disturbing the operation of the antenna. This patch now becomes roughly one-quarter of the wavelength long. To further reduce the length of the patch, the width of the shorting plate can be reduced. The narrower the width of the shorting plate, the shorter the length of the patch can be for a given resonant frequency. The resulting antenna is a PIFA as shown in FIG. 2. The reduction in size from a full-sized patch to a PIFA comes at the expense of the antenna bandwidth. Since the bandwidth of the patch antenna is inversely proportional to the dielectric constant of the substrate between patch and the ground plane, the loss of bandwidth may be partially compensated for by eliminating the dielectric layer in the PIFA.

In essence, a PIFA is a low profile resonant element that is less than one-quarter wavelength long. As shown in FIG. 2, the PIFA includes a conducting plate, or patch, 202 positioned above a ground plane 204. The conducting plate 202 can be formed from sheet metal such as copper or any other good conductor. The conductor plate 202 can also be plated with tin or other similar material to prevent oxidation. A feed line 206 can be used to provide the signal to the conductor plate 202. The feed line can be a coax cable connected to the conductor plate 202 from beneath the ground plane 204, a microstrip line connected to the edge of the conductor plate 202, or any other means known in the art for feeding a PIFA. The conductor plate 202 can be connected to the ground plane 204 through a shorting plate 208.

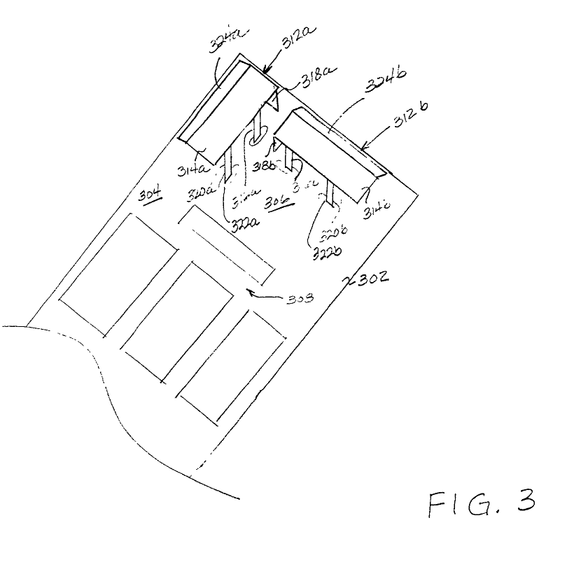

In portable devices, the PIFA may be a good choice for an embedded antenna subsystem because of its reduced size as compared to the microstrip patch antenna, and its relatively wide bandwidth as compared to the inverted F antenna. By way of example, an embedded pair of PIFAs can be used in high data rate modems with a single internal PCB as shown in FIG. 3. In these modem designs, a PCB 302 may be partitioned into a lower section 304 and an upper section 306. The lower section 304 can be dedicated to the electronic components 308 comprising the modem, and the upper section 306 can be dedicated to a pair of PIFAs 312a and 312b. Of course, other component and antenna layouts may be used depending on the design parameters and other relevant factors.

Each PIFA 312a and 312b can be equipped with a conducting plate 314a and 314b formed from tin plated copper or other suitable material. A feed line 316a and 316b can be used to provide the signal to its respective conducting plate 314a and 314b. The feed line 316a and 316b is shown connected to the side of its respective conducting plate 314a and 314b, however, other feed connections may be made. The conducting plates 314a and 314b can be connected to a ground plane (not shown) embedded in the PCB 302 through respective shorting plates 318a and 318b. Each antenna may also be equipped with a supporting leg 320a and 320b which extends from its respective conducting plate 314a and 314b to a nonconductive pad 322a and 322b on the PCB 302. The supporting leg 320a and 320b is electrically floating but provides structural stability to its respective antenna. In at least one embodiment, the antennas can be configured for direct mounting onto the PCB 302 in much the same manner as the electronic components 308.

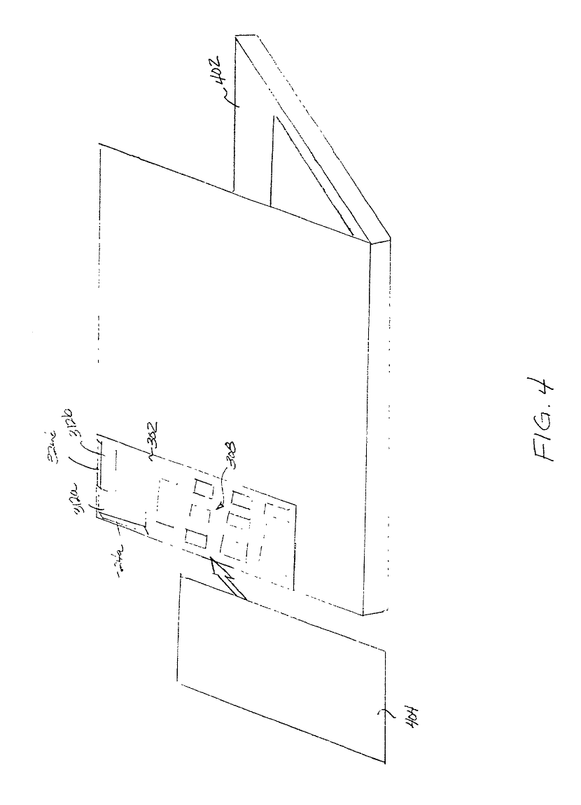

A high data rate modem for a laptop computer application is shown in FIG. 4. In this configuration, the PCB 302 is mounted to the back of the display monitor of a laptop computer 402. The electronic components 308 and antennas 312a and 312b are protected by a radome, or cover, 404 which fits over the PCB 302. The radome 404 is generally flat with tapered edges around the periphery. In the described exemplary embodiment, the available height between the radome 404 and the PCB 302 in the antenna subsystem region varies from less than 1 millimeter (mm) around the periphery to about 6.5 mm in the middle. Accordingly, the PIFAs 312a and 312b should be designed with a relatively low profile not exceeding 4.5 mm. Since, the bandwidth of the PIFAs 312a and 312b are directly proportional to the height of the conducting plate above the ground plane, it is desirable that the PIFAs 312a and 312b be arranged on the PCB 302 to maximize bandwidth. This can be achieved by locating the PIFAs 312a and 312b adjacent the periphery of both the PCB 302 and the laptop computer 404 as shown in FIG. 4. Adjacent means at or sufficiently close to the periphery of the PCB 302 to meet the bandwidth requirements of a particular application for a fixed antenna profile, i.e., thickness. To accommodate the tapered edges of the radome 404, the conducting plates 314a and 314b can be formed with a similar taper, 324a and 324b, respectively, to allow the antenna subsystem to easily fit within the radome 404.

Further increases in performance may be achieved by arranging the PIFAs 312a and 312b perpendicular to one another to enhance the diversity gain of the antenna subsystem through polarization diversity. Diversity gain tends to mitigate fast fading caused by multi-path effects in mobile communications as well as improve the overall throughput of the system. By implementing diversity gain techniques in conjunction with the strategic positioning of the antennas on the PCB, a fully operational embedded antenna subsystem may be provided with sufficient bandwidth for numerous applications including existing PCS bands (1850 MHz to 1990 MHz).

The previous description of the disclosed embodiments is provided to enable any person skilled in the art to make or use the present invention. Various modifications to these embodiments will be readily apparent to those skilled in the art, and the generic principles defined herein may be applied to other embodiments without departing from the spirit or scope of the invention. Thus, the present invention is not intended to be limited to the embodiments shown herein but is to be accorded the widest scope consistent with the principles and novel features disclosed herein.

What is claimed is:

1. An apparatus, comprising:
a board configured to support a plurality of electronic components, the board having a periphery; and
a pair of radiating elements located adjacent the periphery of the board.

2. The apparatus of claim 1 wherein the radiating elements each comprises a planar inverted F antenna.

3. The apparatus of claim 2 wherein the planar inverted F antennas each comprises a thickness less than 4.5 millimeters.

4. The apparatus of claim 2 wherein the planar inverted F antennas each comprises a plate having a first section parallel to the board and a second section having a taper extending from the first section toward the periphery.

5. The apparatus of claim 4 wherein the thickness between the board and the first section of the plate is less than 4.5 millimeters and the thickness between the board and the distal end of the second section is less than 1.0 millimeters.

6. The apparatus of claim 2 wherein the planar inverted F antennas each have a plate having at least a section parallel to the board, the plates being arranged perpendicular to one another.

7. The apparatus of claim 2 wherein the planar inverted F antennas each comprises a feed, a grounding plate coupled to ground, and an electrically floating leg.

8. The apparatus of claim 1 wherein each of the radiating elements includes a plate having at least a section parallel to the board, each of the plates comprising sheet metal.

9. The apparatus of claim 8 wherein the sheet metal for each of the plates comprises tin plated copper.

10. The apparatus of claim 1 wherein the radiating elements are each mounted directly to the board.

11. The apparatus of claim 1 wherein the board includes the electronic components, and wherein the electronic components comprises a modem.

12. The apparatus of claim 1 further comprising a radome enclosing the board and the radiating elements.

13. A method of communications, comprising coupling a signal between a wireless communications medium and a plurality of electronic components supported by a board having a periphery, the coupling of the signal between the wireless communications medium and the electronic components being performed with a pair of radiating elements located adjacent the periphery of the board.

14. The method of claim 13 wherein the radiating elements each comprises a planar inverted F antenna.

15. The method of claim 14 wherein the planar inverted F antennas each comprises a thickness less than 4.5 millimeters.

16. The method of claim 14 wherein the planar inverted F antennas each comprises a plate having a first section parallel to the board and a second section having a taper extending from the first section toward the periphery.

17. The method of claim 16 wherein the thickness between the board and the first section of the plate is less than 4.5 millimeters and the thickness between the board and the distal end of the second section is less than 1.0 millimeters.

18. The method of claim 14 wherein the coupling of the signal further comprises providing diversity gain with the planar inverted F antennas.

19. The method of claim 14 wherein the coupling of the signal further comprises providing perpendicular polarization with the planar inverted F antennas.

20. The method of claim 14 wherein the planar inverted F antennas each comprises a feed, a grounding plate, and third leg, and the coupling of the signal between the wireless communications medium and the electronic components further comprises supplying a signal through each of the feeds, grounding the grounding plates, and providing structural support for each of the planar inverted F antennas with its respective leg.

21. The method of claim 13 wherein each of the radiating elements includes a plate having at least a section parallel to the board, each of the plates comprising sheet metal.

22. The method of claim 21 wherein the sheet metal for each of the plates comprises tin plated copper.

23. The method of claim 13 wherein the radiating elements are each mounted directly to the board.

24. The method of claim 13 wherein the electronic components comprises a modem.

25. The method of claim 13 wherein the coupling of the signal between the wireless communications medium and the electronic components is performed with the board and the radiating elements enclosed in a radome.

26. An apparatus, comprising:
support means for supporting a plurality of electronic components, the support means having a periphery; and
a pair of radiating means for coupling a signal between the electronic components and a wireless communications medium, the radiating means each being located adjacent the periphery of the support means.

27. The apparatus of claim 26 wherein the radiating means each comprises a planar inverted F antenna.

28. The apparatus of claim 27 wherein the planar inverted F antennas each comprises a thickness less than 4.5 millimeters.

29. The apparatus of claim 27 wherein the planar inverted F antennas each comprises a plate having a first section parallel to the board and a second section having a taper extending from the first section toward the periphery.

30. The apparatus of claim 29 wherein the thickness between the board and the first section of th e plate is less than 4.5 millimeters and the thickness between the board and the distal end of the second section is less than 1.0 millimeters.

31. The apparatus of claim 27 wherein the planar inverted F antennas each have a plate having at least a section parallel to the board, the plates being arranged perpendicular to one another.

32. The apparatus of claim 27 further comprising radome means for enclosing the support means and the radiating means.

33. The apparatus of claim 32 wherein the radome means comprises a tapered periphery corresponding to the periphery of the support means, and wherein the radiating means further comprises means for fitting within the radome means between the tapered periphery of the housing means and the support means.

34. The apparatus of claim 27 wherein the planar inverted F antennas each comprises means for receiving a signal, means for grounding, and means for supporting its respective radiating means on the support means.

35. The apparatus of claim 26 wherein each of the radiating means includes a plate having at least a section parallel to the support means, each of the plates comprising sheet metal.

36. The apparatus of claim 35 wherein the sheet metal for each of the plates comprises tin plated copper.

37. The apparatus of claim 26 wherein the radiating means each comprises means for mounting directly to the support means.

38. The apparatus of claim 26 wherein the support means includes the electronic components, and wherein the electronic components comprises a modem.

39. The apparatus of claim 26 further comprising means for enclosing the board and the radiating elements.

40. The apparatus of claim 26 wherein the radiating means comprises means for applying diversity gain to the signal coupled between the wireless communications medium and the electronic components.

41. The apparatus of claim 26 wherein the radiating means are arranged with respect to one another for perpendicular polarization.
